(19) United States
(12) Patent Application Publication
(10) Pub. No.: US 2026/0079986 A1
(43) Pub. Date: Mar. 19, 2026

(54) AUTOMATED SOURCE DATABASE SELECTION AND LONG-TERM MAINTENANCE FOR RAG-BASED SYSTEMS

(71) Applicant: Dell Products L.P., Round Rock, TX (US)

(72) Inventors: Victor da Cruz Ferreira, Rio de Janeiro (BR); Vinicius Michel Gottin, Rio de Janeiro (BR)

(21) Appl. No.: 18/885,287

(22) Filed: Sep. 13, 2024

(51) Int. Cl. G06F 16/33; G06F 16/332; G06F 16/383

(52) U.S. Cl. CPC G06F 16/3349; G06F 16/3326; G06F 16/3344; G06F 16/383

(57) ABSTRACT

A service accesses a RAG system having access to source databases. The source databases are accessible by an LLM tasked with answering user queries. The LLM relies on the source databases to answer the queries. The service accesses a current user query. The service accesses a PQ database of previous user queries that were successfully answered by the LLM. The service retrieves, from the PQ database, a select number of previous user queries that are similar to the current user query. The service identifies source databases used by the LLM to answer those similar user queries. These identified source databases are weighted and ranked. The service generates a subset of source databases by filtering the databases based on the ranked weighted scores. The service tags the subset of source databases as ones the LLM is to potentially use when generating a response to the current user query.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to improving how a RAG system operates. More particularly, at least some embodiments relate to systems, hardware, software, computer-readable media, and methods for intelligently filtering which source databases are used by a RAG system.

### BACKGROUND

Retrieval Augmented Generation (RAG) has brought the attention back into the custom search engine paradigm. This new structure brought a new set of techniques and algorithms that manage databases, large language model (LLM) contexts, and user intention.

In a RAG system, the quality of the response is predicated on the LLM's capabilities and the quality of the retrieval algorithm. The retrieval algorithm relies on a pre-processing step to move internal data (e.g., such as from presentations, reports, etc.) into a context that is readable by an LLM. During this process, it is common to disperse documents into different databases that can be probed independently during the retrieval process.

However, LLMs have a limited context size, thereby limiting the number of sources that can be used to answer a user question. Furthermore, searching an entire ecosystem of many multiple databases is hardly scalable.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example RAG system.

FIG. 2 illustrates a computing architecture for improving a RAG system.

FIG. 3 illustrates a more detailed depiction of the improved architecture.

FIG. 4 illustrates an example of an intelligent source database selection process.

FIG. 5 illustrates a question and answer process flow.

FIG. 6 illustrates an example of a forgetting algorithm and strategy.

FIG. 7 illustrates example experimental data.

FIGS. 8A and 8B illustrate a flowchart of an example method for improving a RAG system.

FIG. 9 illustrates an example computer system that can be configured to perform any of the disclosed operations.

### DETAILED DESCRIPTION

As mentioned previously, RAG is a process that leverages LLMs to generate content given a user query. Relevant attributes for a high quality RAG relate to a high quality retrieval algorithm and a high quality LLM that can take advantage of the algorithm. The retrieval algorithm gathers content from a database and inserts that content into an LLM context (e.g., into an LLM prompt). The LLM can then use the content from the database to answer the query.

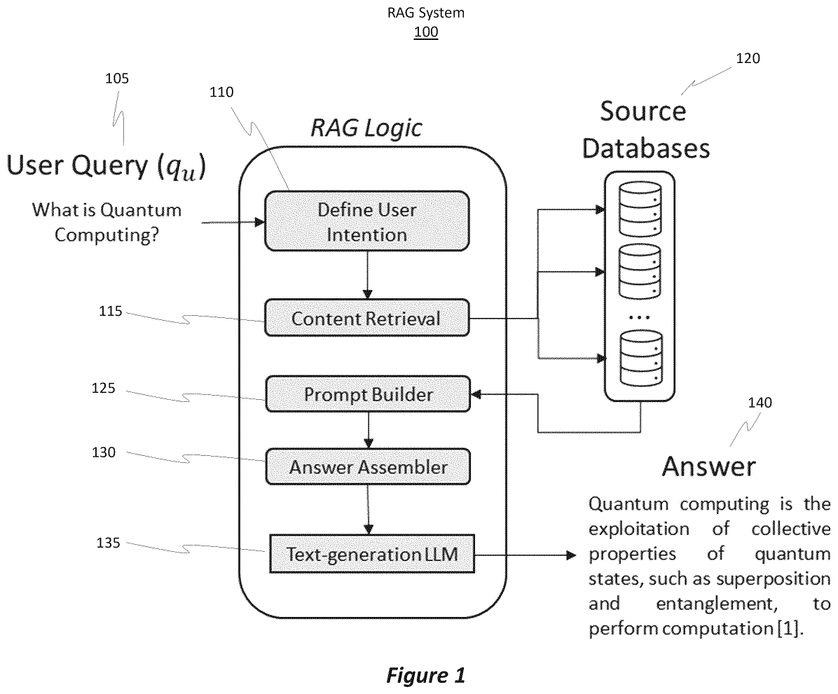

To illustrate, FIG. 1 displays a generic RAG system 100 and its main phases or modules, ranging from receiving a user query 105 to generating an answer. In FIG. 1, the “Define User Intention” module 110 uses the user query 105 to model the rest of the pipeline. Often, these steps involve moderation or the customization of an instruction prompt.

The “Content Retrieval” module 115 then involves querying all available source databases 120 that have pre-processed textual content in a chunk-like manner. These source databases 120 are normally vector databases that support a similarity search operation.

The textual content is returned at the “Prompt Builder” module 125. This module identifies the results that are determined to be most relevant with respect to the user's query. Those results will be used to generate a prompt for the LLM. Because of a limited context size dictated by the “Text-generation LLM” module, the disclosed embodiments allow only the highest ranked sources to be inserted into the prompt.

An answer assembler module 130 will use the prompt as input. This module requests an answer from the text-generation LLM 135, which will produce the desired response or answer 140. Additional steps, such as re-ranking or post-processing on the output of the text-generation LLM, can also be included in some renditions of the RAG system 100.

Some challenges exist, however, with the current configuration of the RAG system 100. For instance, one challenge relates to how the RAG system 100 disambiguates the user's intention across time and between queries without relying on increased computational costs and increased LLM calls. Another challenge relates to how the RAG system 100 automatically defines which of the source databases used by the RAG system 100 will provide the best answer given a particular query. Yet another challenge relates to how the RAG system 100 scales multi-database searches for RAG retrieval to account for any number of databases.

The disclosed embodiments bring about numerous benefits, advantages, and practical applications to RAG systems. That is, the disclosed embodiments provide various improvements to the RAG system 100, and in particular to the “Define User Intention” module. Beneficially, the disclosed embodiments are configured to automatically select which one or more of the source databases are better suited to answer the current query, thereby improving the RAG system's scalability and improving the user's experience (e.g., because a better answer will be provided). The disclosed embodiments also beneficially provide a mechanism to keep the retrieval algorithm up-to-date, thereby accounting for changes to the source databases and to the user's intention over time.

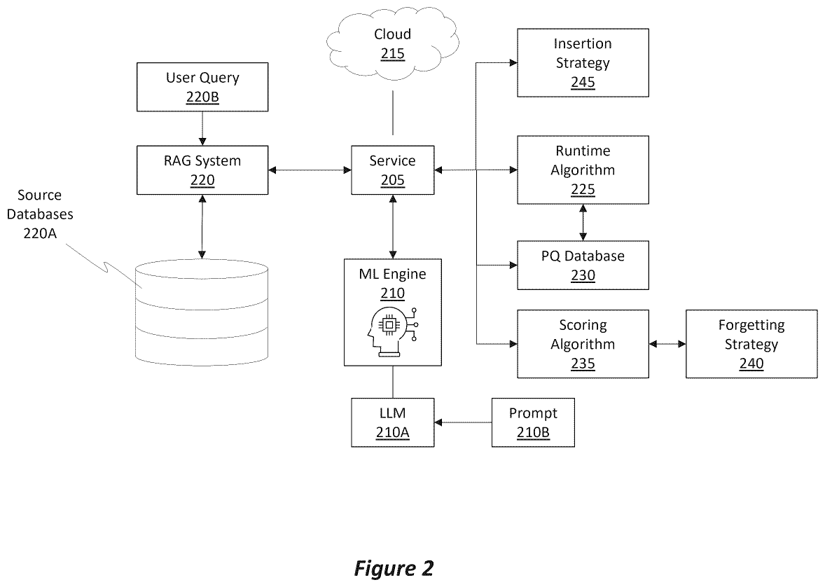

Having just described some of the various advantages provided by the disclosed embodiments, attention will now be directed to FIG. 2, which illustrates an example architecture 200 in which the disclosed principles may be employed. Architecture 200 shows a service 205.

As used herein, the term “service” refers to an automated program that is tasked with performing different actions based on input. In some cases, service 205 can be a deterministic service that operates fully given a set of inputs and without a randomization factor. In other cases, service 205 can be or can include a machine learning (ML) or artificial intelligence engine, such as ML engine 210. The ML engine 210 enables service 205 to operate even when faced with a randomization factor. The ML engine 210 can include or implement a large language model (LLM) 210A.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 205 is a local service operating on a local device. In some implementations, service 205 is a cloud service operating in a cloud 215 environment. In some implementations, service 205 is a hybrid service that includes a cloud component operating in the cloud 215 and a local component operating on a local device. These two components can communicate with one another.

Service 205 is generally tasked with improving the functioning of a RAG system 220 having or being associated with any number of source databases 220A, which correspond to the source databases 120 of FIG. 1. In particular, service 205 is tasked with implementing a runtime algorithm 225 that automatically chooses which one or more of the source databases 220A are to be used to answer a given user query 220B in the RAG system 220. This intelligent selection or filtering process improves the overall scalability of RAG system 220 and can improve answer quality because more focused and relevant source databases will end up being used by the text-generation LLM prompt 210B. Service 205 can leverage a database referred as a past query (PQ) database 230 that stores previous successful choices from the runtime algorithm 225.

Each entry in the PQ database 230 includes (i) an embedding of a previous query, (ii) the source database that is to be selected for the query, and (iii) timestamp data indicating when the entry was created and/or when it was successfully used. As used herein, the term “embedding” refers to a numerical representation of a collection of words (e.g., the user query), and that numerical representation captures an essence or a meaning of the words, including the semantic relationship of the words.

Service 205 also automates the selection of source databases in a manner that leverages or accounts for user intention drift. The automated selection process advantageously increases retrieval scalability and can also improve response quality. Service 205 is also configured to implement a scoring algorithm 235 that takes into account a forgetting strategy 240.

That is, service 205 can leverage a distance metric with a “rotten” factor based on an adapted spatial biased amnesia (SBA) forgetting strategy (i.e. forgetting strategy 240). This distance scoring metric will penalize outdated queries on the PQ database 230. The adaptation of the SBA algorithm for vector databases can tag entries as rotten according to different time-related fields and embedding distances.

With reference to both FIG. 1 and FIG. 2, service 205 can start at the first step (i.e. Define User Intention module 110) of the RAG system 100. As mentioned previously, the first step involves the definition of a user intention after a user query 105 is received. An embedding of the user query is forwarded to the PQ database 230 in order to retrieve the top k most similar stored queries relative to the current user query. The top k most similar queries can be identified using a distance function.

With these k most similar queries, service 205 accumulates a weighted score per source database present in those queries. At the end of the process, service 205 can rank these scores using an appropriate strategy, such as selecting all non-zero scoring source databases or selecting the top-p highest scoring source databases. Thus, instead of relying on all of the source databases 220A, service 205 helps to selectively filter the source databases 220A so that only a limited subset (likely not all) of the source databases 220A will be used in the prompt 210B for the LLM 210A.

Stated differently, these selected source databases will be the only ones (or at least the ones designated as being preferable) to be probed in case of time constraints at the retrieval step. Performing this filtering operation acts to automatically define which source databases are considered best for use when answering the current user query based on historical data of similar queries. As indicated above, the disclosed principles are flexible enough to allow other source databases to be used by the LLM 210A, but the ones that are identified by service 205 are ones that are determined to be most relevant for the LLM 210A. Thus, the disclosed embodiments allow for situations in which other source databases not included in the filtered list are used.

Note, the PQ database 230 can initially be filled in or seeded with artificial or controlled test queries during an offline phase. The PQ database 230 can also be populated over time with user-provided queries, to thereby leverage the feedback mechanisms present in the RAG system.

To deal with source database updates that may change user intention over time, service 205 can implement an insertion strategy 245 and the forgetting strategy 240 to keep the PQ database 230 up-to-date. Regarding the insertion strategy 245, service 205 can identify when the runtime algorithm 225 correctly selects source databases deemed to be worthwhile (e.g., because they are actually used by the LLM 210A) and can add the successfully completed user query to the PQ database 230. To determine success, service 205 can leverage answer metadata and can evaluate if the feedback from the user was positive. Service 205 can also determine which source database were actually used by the LLM 210A to provide an answer. The PQ database 230 can include both the successful user queries as well as an indication as to which source databases were used to answer those successful user queries.

Regarding the forgetting strategy 240, service 205 can adapt the spatial biased amnesia (SBA) algorithm (i.e. the forgetting strategy 240) by choosing the oldest samples as centroids to form an evaluation area of “rot.” Every point within the area is evaluated based on its “successfully used at” timestamp field. Each point will be tagged as rot if it has not been used for a threshold amount of time. This rot factor is leveraged during the distance calculation used at the runtime.

It should be noted how the source databases 220A are described herein as databases that contain different textual source content pre-processed to be ingested as an LLM context. Although the source databases 220A are often referred to as databases, the term “database” can be used interchangeably with any other structure(s) that can be filtered at run time.

The solution provided by service 205 can generally be divided into two phases. One phase involves the runtime automatic selection of one or more source databases. A second phase involves the long-term update to the PQ database 230.

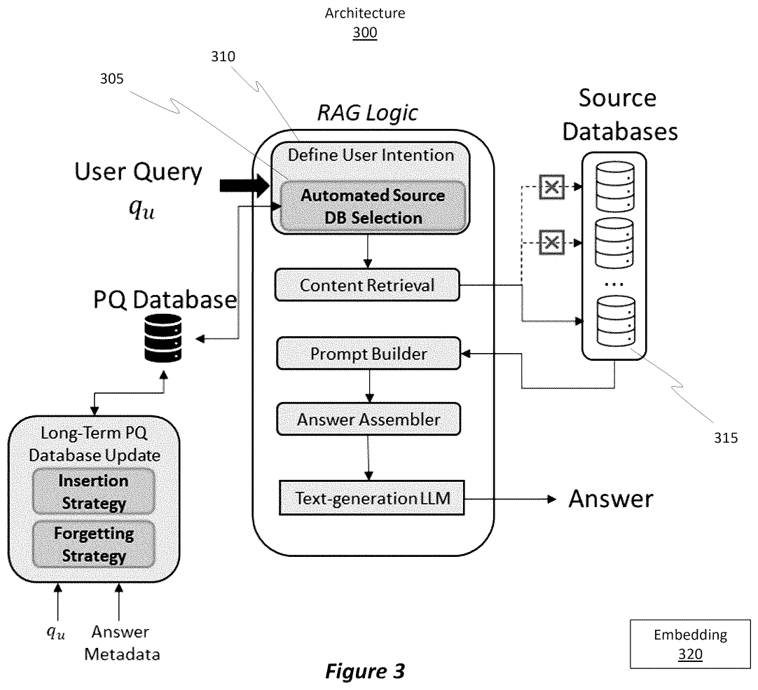

The disclosed operations beneficially leverage the user query 220B at the RAG system 220's user intention classification step (e.g., Define User Intention module 110 of FIG. 1) to decide which one or more source databases are to be selected to better answer the current user query while accounting for drifting source themes and user query intentions by updating the PQ database 230. FIG. 3 provides some additional details.

FIG. 3 shows an overview of the disclosed architecture 300 in which the defined processes fit into a generic RAG System. The Automated Source DB Selection 305 is located at the “Define User Intention” process 310 and will define which source databases are selected. Following the depiction in FIG. 3, one can observe an example where only the last source database 315 is selected to answer the user query. To the left side, architecture 300 shows the PQ database and both strategies used to update the PQ database to avoid source and user intention drifts. It should be noted how the PQ database includes embeddings (e.g., embedding 320) for the previously answer user queries.

The disclosed solution is based on an insight that user queries are semantically/contextually different depending on which source data the user is looking for. For example, when querying with the intention of using “BattleCard Database” (e.g., a database comparing certain products against competitors in the market), user queries tend to be comparative and tend to mention specific products.

Regarding the automatic source database selection process, this process is the runtime stage in which a user performs a query (qᵤ) at a RAG system. Service 205 of FIG. 2 then narrows down which source databases are better suited to answer the query qᵤ.

The selection process leverages the PQ database, which stores embedding information on past queries (Q) as well as control information such as which source database(s) (τ) better answers a given q.

Service 205 is not limited to any specific database technology, as long as the ability to store embeddings and control information regarding each entry q∈Q is preserved and as long as the ability to calculate distance function D (qᵤ, q), such as Euclidian distance, is preserved, any such technique can be used. A vector database is one example option; however, clustering and standard relational databases can be leveraged as well to achieve the same result.

With reference to FIG. 3, before the deployment of the RAG system, the PQ database is populated with previously tested queries that are known to be answered by specific sources. For example, a query q=“How do I configure iDRAC on my PowerEdge r750?” will be embedded and inserted into the PQ database referencing its ground truth source database as τ=“Manuals Database”.

The embodiments can also have two time-related fields (perhaps named “Created At” and “Successfully used at”) that can play a role in the forgetting strategy. The “Created at” field can be updated at the moment of insertion of q, and the “Successfully used at” field can be updated when certain restrictions presented later are matched.

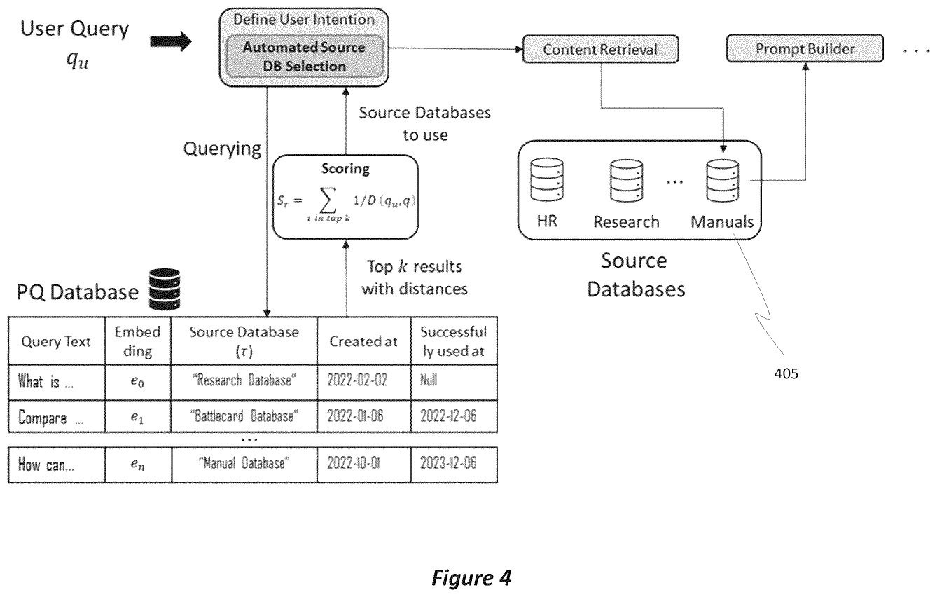

FIG. 4 illustrates an example selection process 400 regarding how the runtime algorithm automatically defines which source databases will be selected. During runtime, when a user performs qᵤ, at the define user intention phase, the runtime algorithm will go over the PQ database to perform a search over the PQ database so as to return the top k entries with smaller distance. A maximum distance threshold can be defined and implemented. Both k and the distance threshold can be fine-tuned depending on the use-case system, embedding algorithm, and database software choice.

After retrieving the most similar queries qᵤ, the algorithm enters a scoring phase. The score S is calculated per returned source database metadata using the following formula:

$${S}_{τ} = {\sum }_{τ in top k} 1 / D ( {q}_{u} , q )$$

Service 205 can accumulate a score for each returned t in the top k results. At the end of the accumulation, service 205 can rank which source databases are the highest scoring ones and use them in the Content Retrieval module 115 of FIG. 1. FIG. 4 also shows a case where only the “Manuals” source database 405 is selected to be used to build the prompt and to move the RAG logic forward.

At this point, any strategy can be implemented to choose how many source databases are to be forwarded to the retrieval algorithm. One example strategy involves selecting all non-zero scoring source databases. Another strategy involves selecting the top-p highest scoring ones.

In case no result is returned when querying over qᵤ, a possible strategy is to query the most recently updated source databases. Notably, however, this scenario should happen less and less frequently as the RAG system is used and as the long-term database update algorithm populates the PQ database over time.

It should be noted how the forgetting strategy is a mechanism that allows the PQ database to evolve and to account for changes in the domain. As a consequence of that mechanism, service 205 can substitute the above mentioned distance function for one that accounts for “rotting” (i.e. weighted forgetting) of entries Dᵣₒₜ(qᵤ, q). Further details on this aspect will be provided shortly.

The disclosed principles beneficially allow improved scalability as, in most cases, few source databases will be queried and a more targeted response should be used to improve the chatbot answer's quality as long as the correct databases were selected. The disclosed principles also decrease the entry barrier for usage and enhance the user experience because the users are not obligated to know which database to query for.

Further details will now be presented for the long-term PQ database update. To maintain a comprehensive long-term system, service 205 provides an option to update the PQ database by leveraging positive past user iterations for insertion and by forgetting certain stored user query data. The presented continuous update mechanism is motivated by the mutable environment present in RAG-based chatbots.

These environments have new sources being constantly added into the source databases as well as user intention drift over time. For example, a query on quantum computing may be strictly for research databases as of today. In the future, however, most of the queries might fall into manuals or other product-related databases.

Service 205 can provide an algorithm and guidelines on how to go about regarding addition of user queries into the PQ database after the offline phase. This process can be carried out at any point, including online at runtime or during idle times in a batch fashion.

Because analyzing chatbot answer quality is a challenge, it can be difficult to evaluate if a source was correctly selected and used in the LLM generated response. Therefore, the disclosed embodiments can optionally present a set of conditions that a query must adhere to in order to be inserted into the PQ database. The conditions are listed below.

One condition relates to positive user feedback. Many chatbots have some type of user feedback, mostly in the format of a binary evaluation (e.g., thumbs up or down). This feedback technique is quite beneficial because it indicates the response was answered successfully by the RAG system. Therefore, the used sources and database selection was effective.

Another condition relates to an answer explicit reference or footnote. It is commonplace that RAG systems present links and mentions of sources referenced in the context and used in the answer. The disclosed embodiments can leverage these references to guide which sources were used in the response, as many sources may go into the LLM final prompt, but only a few are used by the LLM for the final answer.

In summary, to insert a query qᵤ into the PQ database, that query will likely be one that has been voted positively by the user. τ will be defined by checking which source databases were referenced at the final answer.

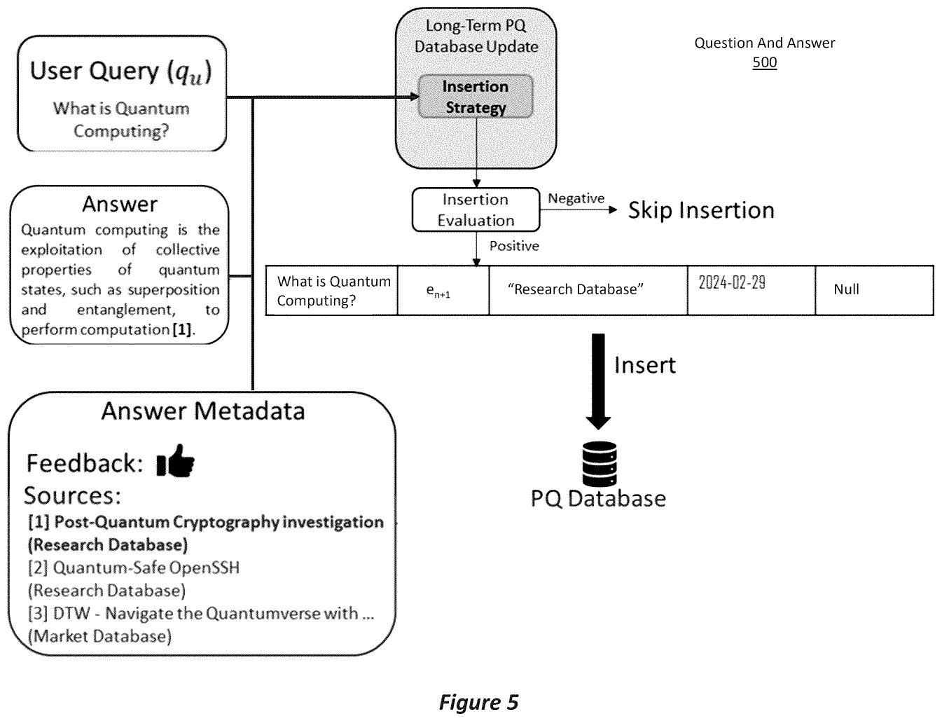

FIG. 5 shows an example of a question and answer 500 scenario. In this example, the answer received a thumbs up and only references the source [1], which means source [1] can be added as a new entry to the PQ database with τ=“Research Database”. If doing a batched analysis, additional steps can be carried such as removal of exactly matching qᵤ's and ignoring queries that trigger static template answers.

Notice that, if the RAG system provides an interface where the user can both use the automated source based selection and manually select databases, the embodiments can provide a higher weight for queries with a thumbs up where the user manually selected a specific source database. In such a scenario, the user might be a specialist and does not have ambiguous intentions. These same constraints can be used to update the field “Successfully used at” with the latest timestamp for a query already present at the PQ database that does not need to be re-inserted. This insertion process greatly minimizes the likelihood of inserting queries referencing the wrong source databases. These processes performed over time will help improve matches for every user performing a similar question in the RAG system.

Further details will now be provided for the forgetting strategy. Because the selection algorithm uses the top k with an optional distance threshold, just inserting new qᵤ into the PQ database may not properly deal with user intention and source content drift present in RAG systems. Following the previous example, if the “Quantum Computing” subject becomes more likely to be part of a product-related base, the embodiments can make sure previous q stored with τ=“Research Database” are penalized or partially forgotten as to make way for q that have product-related τ; otherwise, few thumbs up may occur as only “Research Database” is selected to be probed at runtime for this type of query.

The embodiments can draw from a spatial biased amnesia (SBA) algorithm to penalize or remove q at Q. The SBA is based on the concept that magnetic disk hardware errors are spatially highly correlated. Therefore, it will forget clumps (or “rotten”) areas within a set.

Because the PQ database leverages semantic embeddings using a distance metric, similar queries on similar subjects and semantic meanings are naturally grouped together as they will have smaller distances. In case the selected technology to host the PQ database is already cluster-based, this result will be straight forward. Otherwise, clusters can be constructed heuristically or extensively depending on computational availability.

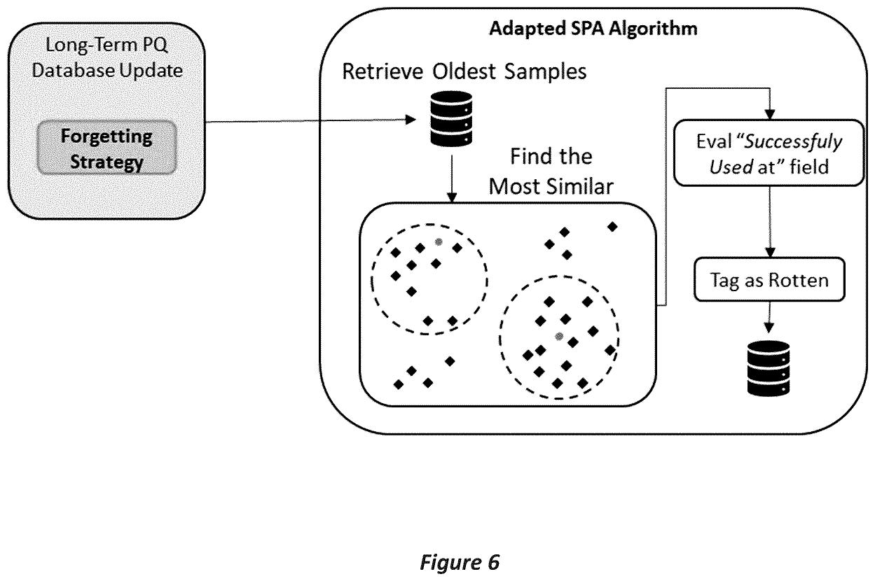

FIG. 6 showcases the steps performed during the SBA algorithm 600. During idle times, service 205 can apply the SBA algorithm 600, thereby identifying queries based on the two time-base fields introduced earlier (e.g., “Last Successfully Used” and “Created at”). Given a time threshold, which is use-case based, service 205 will select the oldest created at queries (qₜ∈Qₜ) at the base as potential contenders.

Every qₜ will be used as centroids of the rotten area. Note that the rotten area comes for free just by querying qₜ similarly to how it is performed for qᵤ. For every tuple returned from querying over qₜ, service 205 will flag as rotten all q that were not “successfully used” below a threshold. Note that this may or may not include qₜ itself, as the selection process for qₜ considers only the “Created at” field and is also guaranteed to be returned in a query as qₜ∈Q.

Penalizing the distance by modifying the distance calculation to consider an additional rotten factor (e.g., such as the new distance calculation) is often a more preferred strategy as compared to simply removing q all together from the database because there might still be users who are interested at the specific τ, present in q. Furthermore, the SBA algorithm 600 can be modified to have increasing rotten levels or can be modified to completely remove q if rotten for too long.

Below, the disclosure presents an updated distance calculation to be used at runtime score (S_{τ}), which leverages a rotten factor.

$${D}_{r o t} ( {q}_{u} , q ) = D ( {q}_{u} , q ) * ro t ( q )$$

Here rot(q) is a scale factor that is crafted based on the distance function scope. As an example, the embodiments can apply a time-based function such as rot(q)=(2*time_{now}−q_{sucessfully_used_at})/time_{now}. Such rotten function will penalize by scaling up the distance the longer the query has not been successfully used.

The SBA algorithm 600 can execute periodically depending on the number of entities using the RAG system and how often new data is inserted into the source databases. As various examples, this update frequency can be monthly, weekly, or yearly.

The following paragraphs will now outline some experimental results. As mentioned before, the disclosed solutions are based on an insight that user queries are semantically/contextually different depending on which source data a user is looking for. To validate this intuition, an experiment was organized, where this experiment emulates the runtime database selection presented herein.

In this example scenarios, one RAG system (herein referred to as “Jarvis”) is configured to use a ChromaDB with collections as a way to separate different source databases. Jarvis has been configured to ingest ORO data consisting of Jira and Sharepoints related to Jira's (“oro”), BattleCards, and product manual data (“manual”).

The embodiments populate the PQ Database, also using a ChromaDB, with 100 real queries for each source database available (oro, BattleCards, and manual), totaling 300 entries at the PQ database. This is similar to the offline stage described earlier, and the ground truth source database (τ*) is established.

The embodiments then use the remaining 645 queries to emulate the runtime behavior and to verify the top 1, 2, and 3 accuracy. Top 1 accuracy means the highest scoring S_{τ} matches the ground τ* from the current query. Top 2 means the τ* is present at the two highest S_{τ} scores and so forth. No preprocessing was performed on the 300 queries added to the database offline nor to the 645 probed queries.

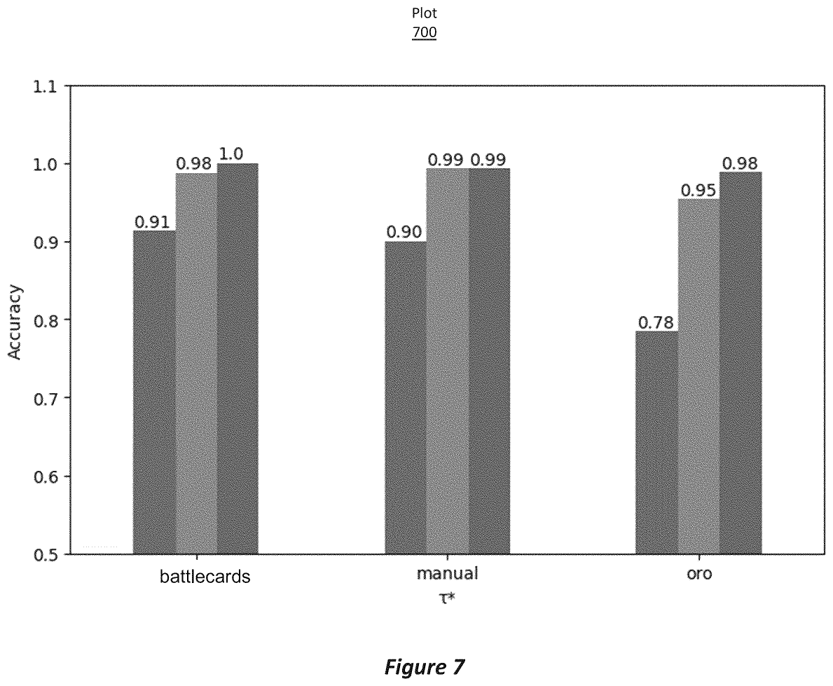

FIG. 7 shows a plot 700 the top accuracy results. In each group of three columns, the lefthand column reflects the top 1 data, the middle column reflects the top 2 data, and the righthand column reflects the top 3 data.

As shown, both manuals and BattleCards have very distinct query behaviors achieving 90% or more accuracy at the top 1 (i.e. the lefthand column in each group of three columns), while the ORO base appears to have a more overlapping structure. However, if one were to move into choosing the top 2 highest scoring source databases, all probabilities exceed 95% accuracy, thereby providing strong evidence on real query data that the disclosed approach for automatically selecting source databases is fruitful.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

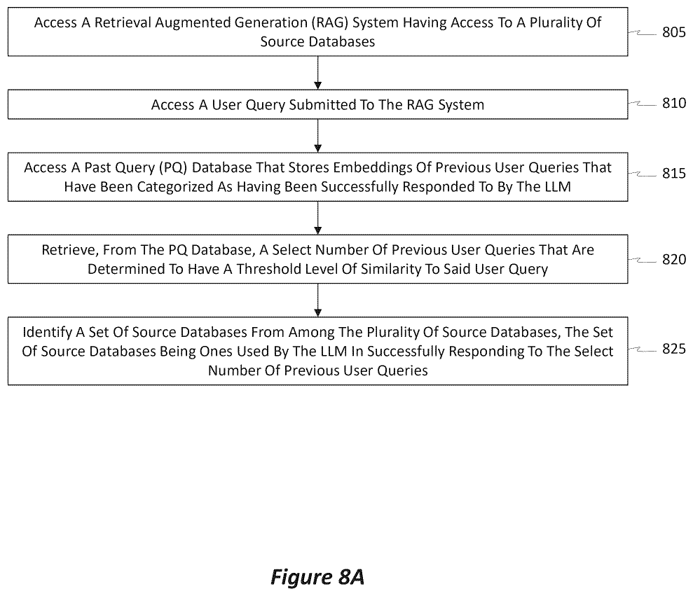

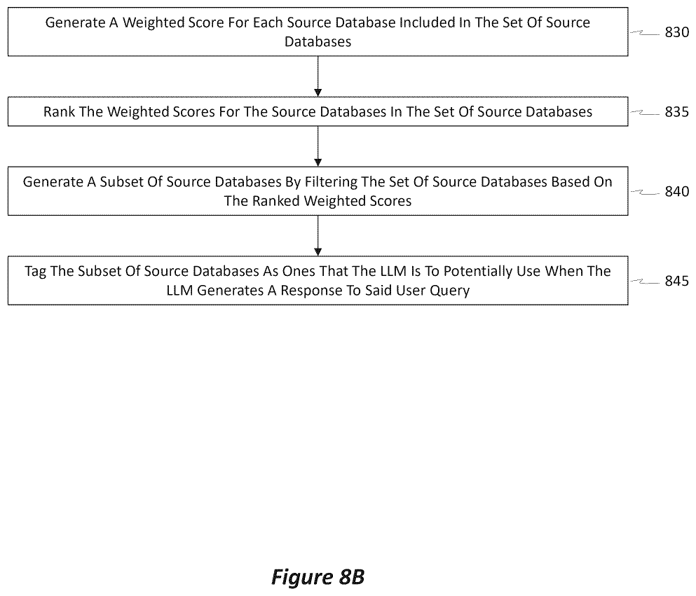

Attention will now be directed to FIGS. 8A and 8B, which illustrate a flowchart of an example method 800 for automatically selecting a set of source databases for use in a RAG system. Method 800 can be implemented within architecture 200 of FIG. 2; furthermore, method 800 can be implemented by service 205.

As shown in FIG. 8A, method 800 includes an act (act 805) of accessing a retrieval augmented generation (RAG) system having access to a plurality of source databases. For instance, the RAG system 220 of FIG. 2 and the source databases 220A can be accessed. The plurality of source databases are accessible by a large language model (LLM) (e.g., LLM 210A of FIG. 2) that is tasked with answering user queries. The LLM relies on the plurality of source databases to answer the user queries.

Act 810 includes accessing a user query (e.g., user query 220B of FIG. 2) submitted to the RAG system. An embedding (e.g., embedding 32) is generated for the user query.

Act 815 includes accessing a past query (PQ) database (e.g., PQ database 230) that stores embeddings of previous user queries. These previous user queries are ones that have been categorized as having been successfully responded to by the LLM.

Act 820 includes retrieving, from the PQ database, a select number of previous user queries. These specific queries are ones that are determined to have a threshold level of similarity to the current user query.

Act 825 includes identifying a set of source databases from among the plurality of source databases. This set of source databases are ones used by the LLM in successfully responding to the select number of previous user queries.

Method 800 then continues in FIG. 8B. Act 830 in FIG. 8B includes generating a weighted score for each source database included in the set of source databases. In some implementations, the process of generating the subset of source databases by filtering the set of source databases based on the ranked weighted scores includes selecting all source databases having non-zero weighted scores. In some implementations, the process of generating the subset of source databases by filtering the set of source databases based on the ranked weighted scores includes a top-p highest number of weighted source databases.

Act 835 includes ranking the weighted scores for the source databases in the set of source databases.

Act 840 includes generating a subset of source databases by filtering the set of source databases based on the ranked weighted scores. In some scenarios, a number of source databases included in the subset of source databases is less than 50% of a number of source databases included in the plurality of source databases. In some scenarios, the number is less than 25%, or less than 10%, or perhaps even less than 5%. As a particular example, the number of source databased included in the subset may be less than 10, or less than 5, such as perhaps 4, 3, 2, or even 1. Of course, the number can be set to any value.

Act 845 includes tagging the subset of source databases as ones that the LLM is to potentially use when the LLM generates a response to said user query. By tagging the source databases, the embodiments operate to transform the data in response to the operations performed herein. In some scenarios, the process of tagging the subset of source databases involves adding the subset of source databases to a prompt for the LLM.

Regarding the PQ database, a new embedding entry can be added to the PQ database in response to user feedback. Optionally, a new embedding entry can be added to the PQ database in response to answer metadata associated with an answer the LLM generates for the user query. Typically, the PQ database is governed by a forgetting algorithm that operates to remove certain embeddings from the PQ database. Similarly, the PQ database can be governed by an insertion algorithm that operates to add new embeddings to the PQ database. The PQ database can also be updated in an attempt to avoid source database content drift in the RAG system. In some cases, the PQ database is a cluster-based database. In some cases, the PQ database is structured to leverage semantic embeddings using a distance metric, such that user queries that are related to one another are grouped together in the PQ database.

In some implementations, method 800 can further include an act of generating a prompt for the LLM to answer the user query. Optionally, the prompt can include a listing of the subset of source databases.

In some implementations, method 800 further includes an act of causing the LLM to execute the prompt, resulting in the LLM generating an answer to the user query. Optionally, the LLM generates the answer to the user query by querying at least one source database included in the subset of source databases.

In some implementations, after the LLM provides an answer to the user query using one or more source databases included in the subset of source databases, user feedback is received. The user feedback can indicate either success or failure on a part of the LLM in providing the answer. Optionally, the PQ database can then be updated based on the user feedback. In some scenarios, some, but not all, of the source databases in the subset of source databases are used by the LLM in generating an answer to the user query. Also, in some cases, during an offline phase of the PQ database, the PQ database is seeded with initial embedding data.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

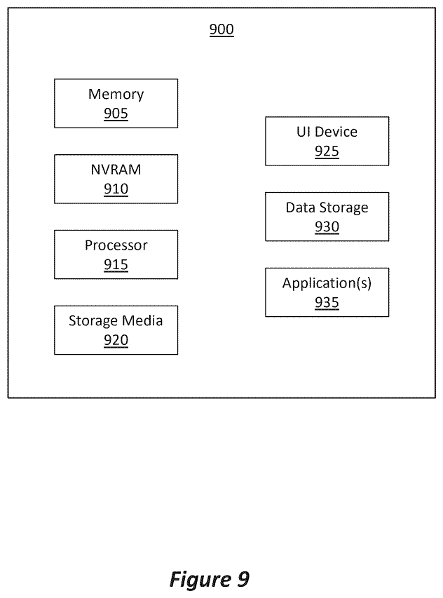

With reference briefly now to FIG. 9, any one or more of the entities disclosed, or implied, by the Figures and/or elsewhere herein, may take the form of, or include, or be implemented on, or hosted by, a physical computing device, one example of which is denoted at 900. Also, where any of the aforementioned elements comprise or consist of a virtual machine (VM), that VM may constitute a virtualization of any combination of the physical components disclosed in FIG. 9.

In the example of FIG. 9, the physical computing device 900 includes a memory 905 which may include one, some, or all, of random access memory (RAM), non-volatile memory (NVM) 910 such as NVRAM for example, read-only memory (ROM), and persistent memory, one or more hardware processors 915, non-transitory storage media 920, UI device 925, and data storage 930. One or more of the memory 905 of the physical computing device 900 may take the form of solid-state device (SSD) storage. Also, one or more applications 935 may be provided that comprise instructions executable by one or more hardware processors to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 900 may also be representative of an edge system, a cloud-based system, a datacenter or portion thereof, or other system or entity.

The disclosed embodiments can be implemented in numerous different ways, as described in the various different clauses recited below.
Clause 1. A method comprising: accessing a retrieval augmented generation (RAG) system having access to a plurality of source databases, wherein the plurality of source databases are accessible by a large language model (LLM) that is tasked with answering user queries, the LLM relying on the plurality of source databases to answer the user queries; accessing a user query submitted to the RAG system, wherein an embedding is generated for the user query; accessing a past query (PQ) database that stores embeddings of previous user queries that have been categorized as having been successfully responded to by the LLM; retrieving, from the PQ database, a select number of previous user queries that are determined to have a threshold level of similarity to said user query; identifying a set of source databases from among the plurality of source databases, the set of source databases being ones used by the LLM in successfully responding to the select number of previous user queries; generating a weighted score for each source database included in the set of source databases; ranking the weighted scores for the source databases in the set of source databases; generating a subset of source databases by filtering the set of source databases based on the ranked weighted scores; and tagging the subset of source databases as ones that the LLM is to potentially use when the LLM generates a response to said user query.
Clause 2. The method of any of the preceding clauses, wherein generating the subset of source databases by filtering the set of source databases based on the ranked weighted scores includes selecting all source databases having non-zero weighted scores.
Clause 3. The method of any of the preceding clauses, wherein generating the subset of source databases by filtering the set of source databases based on the ranked weighted scores includes a top-p highest number of weighted source databases.
Clause 4. The method of any of the preceding clauses, wherein a new embedding entry is added to the PQ database in response to user feedback.
Clause 5. The method of any of the preceding clauses, wherein a new embedding entry is added to the PQ database in response to answer metadata associated with an answer the LLM generates for the user query.
Clause 6. The method of any of the preceding clauses, wherein the PQ database is governed by a forgetting algorithm that operates to remove certain embeddings from the PQ database.
Clause 7. The method of any of the preceding clauses, wherein the PQ database is governed by an insertion algorithm that operates to add new embeddings to the PQ database.
Clause 8. The method of any of the preceding clauses, wherein the PQ database is updated in an attempt to avoid source database content drift in the RAG system.
Clause 9. The method of any of the preceding clauses, wherein the PQ database is a cluster-based database.
Clause 10. The method of any of the preceding clauses, wherein the PQ database is structured to leverage semantic embeddings using a distance metric, such that user queries that are related to one another are grouped together in the PQ database.
Clause 11. One or more hardware storage devices that store instructions that are executable by one or more processors to cause the one or more processors to: access a retrieval augmented generation (RAG) system having access to a plurality of source databases, wherein the plurality of source databases are accessible by a large language model (LLM) that is tasked with answering user queries, the LLM relying on the plurality of source databases to answer the user queries; access a user query submitted to the RAG system, wherein an embedding is generated for the user query; access a past query (PQ) database that stores embeddings of previous user queries that have been categorized as having been successfully responded to by the LLM; retrieve, from the PQ database, a select number of previous user queries that are determined to have a threshold level of similarity to said user query; identify a set of source databases from among the plurality of source databases, the set of source databases being ones used by the LLM in successfully responding to the select number of previous user queries; generate a weighted score for each source database included in the set of source databases; rank the weighted scores for the source databases in the set of source databases; generate a subset of source databases by filtering the set of source databases based on the ranked weighted scores; and tag the subset of source databases as ones that the LLM is to potentially use when the LLM generates a response to said user query.
Clause 12. The one or more hardware storage devices of any of the preceding clauses, wherein the instructions are further executable to cause the one or more processors to: generate a prompt for the LLM to answer the user query, wherein the prompt includes a listing of the subset of source databases.
Clause 13. The one or more hardware storage devices of any of the preceding clauses, wherein the instructions are further executable to cause the one or more processors to: cause the LLM to execute the prompt, resulting in the LLM generating an answer to the user query, wherein the LLM generates the answer to the user query by querying at least one source database included in the subset of source databases.
Clause 14. The one or more hardware storage devices of any of the preceding clauses, wherein tagging the subset of source databases involves adding the subset of source databases to a prompt for the LLM.
Clause 15. The one or more hardware storage devices of any of the preceding clauses, wherein a number of source databases included in the subset of source databases is less than 50% of a number of source databases included in the plurality of source databases.
Clause 16. The one or more hardware storage devices of any of the preceding clauses, wherein a number of source databases included in the subset of source databases is less than 5.
Clause 17. The one or more hardware storage devices of any of the preceding clauses, wherein, after the LLM provides an answer to the user query using one or more source databases included in the subset of source databases, user feedback is received, the user feedback indicating either success or failure on a part of the LLM in providing the answer, and wherein the PQ database is updated based on the user feedback.
Clause 18. The one or more hardware storage devices of any of the preceding clauses, wherein, during an offline phase of the PQ database, the PQ database is seeded with initial embedding data.
Clause 19. The one or more hardware storage devices of any of the preceding clauses, wherein some, but not all, of the source databases in the subset of source databases are used by the LLM in generating an answer to the user query.
Clause 20. A computer system comprising: one or more processors; and one or more hardware storage devices that store instructions that are executable by one or more processors to cause the computer system to: access a retrieval augmented generation (RAG) system having access to a plurality of source databases, wherein the plurality of source databases are accessible by a large language model (LLM) that is tasked with answering user queries, the LLM relying on the plurality of source databases to answer the user queries; access a user query submitted to the RAG system, wherein an embedding is generated for the user query; access a past query (PQ) database that stores embeddings of previous user queries that have been categorized as having been successfully responded to by the LLM; retrieve, from the PQ database, a select number of previous user queries that are determined to have a threshold level of similarity to said user query; identify a set of source databases from among the plurality of source databases, the set of source databases being ones used by the LLM in successfully responding to the select number of previous user queries; generate a weighted score for each source database included in the set of source databases; rank the weighted scores for the source databases in the set of source databases; generate a subset of source databases by filtering the set of source databases based on the ranked weighted scores; and tag the subset of source databases as ones that the LLM is to potentially use when the LLM generates a response to said user query.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. It should also be noted how any feature recited herein can be combined with any other feature recited herein.

What is claimed is:

1. A method comprising:
accessing a retrieval augmented generation (RAG) system having access to a plurality of source databases, wherein the plurality of source databases are accessible by a large language model (LLM) that is tasked with answering user queries, the LLM relying on the plurality of source databases to answer the user queries;
accessing a user query submitted to the RAG system, wherein an embedding is generated for the user query;
accessing a past query (PQ) database that stores embeddings of previous user queries that have been categorized as having been successfully responded to by the LLM;
retrieving, from the PQ database, a select number of previous user queries that are determined to have a threshold level of similarity to said user query;
identifying a set of source databases from among the plurality of source databases, the set of source databases being ones used by the LLM in successfully responding to the select number of previous user queries;
generating a weighted score for each source database included in the set of source databases;
ranking the weighted scores for the source databases in the set of source databases;
generating a subset of source databases by filtering the set of source databases based on the ranked weighted scores; and
tagging the subset of source databases as ones that the LLM is to potentially use when the LLM generates a response to said user query.

2. The method of claim 1, wherein generating the subset of source databases by filtering the set of source databases based on the ranked weighted scores includes selecting all source databases having non-zero weighted scores.

3. The method of claim 1, wherein generating the subset of source databases by filtering the set of source databases based on the ranked weighted scores includes a top-p highest number of weighted source databases.

4. The method of claim 1, wherein a new embedding entry is added to the PQ database in response to user feedback.

5. The method of claim 1, wherein a new embedding entry is added to the PQ database in response to answer metadata associated with an answer the LLM generates for the user query.

6. The method of claim 1, wherein the PQ database is governed by a forgetting algorithm that operates to remove certain embeddings from the PQ database.

7. The method of claim 1, wherein the PQ database is governed by an insertion algorithm that operates to add new embeddings to the PQ database.

8. The method of claim 1, wherein the PQ database is updated in an attempt to avoid source database content drift in the RAG system.

9. The method of claim 1, wherein the PQ database is a cluster-based database.

10. The method of claim 1, wherein the PQ database is structured to leverage semantic embeddings using a distance metric, such that user queries that are related to one another are grouped together in the PQ database.

11. One or more hardware storage devices that store instructions that are executable by one or more processors to cause the one or more processors to:
access a retrieval augmented generation (RAG) system having access to a plurality of source databases, wherein the plurality of source databases are accessible by a large language model (LLM) that is tasked with answering user queries, the LLM relying on the plurality of source databases to answer the user queries;
access a user query submitted to the RAG system, wherein an embedding is generated for the user query;
access a past query (PQ) database that stores embeddings of previous user queries that have been categorized as having been successfully responded to by the LLM;
retrieve, from the PQ database, a select number of previous user queries that are determined to have a threshold level of similarity to said user query;
identify a set of source databases from among the plurality of source databases, the set of source databases being ones used by the LLM in successfully responding to the select number of previous user queries;
generate a weighted score for each source database included in the set of source databases;
rank the weighted scores for the source databases in the set of source databases;
generate a subset of source databases by filtering the set of source databases based on the ranked weighted scores; and
tag the subset of source databases as ones that the LLM is to potentially use when the LLM generates a response to said user query.

12. The one or more hardware storage devices of claim 11, wherein the instructions are further executable to cause the one or more processors to:
generate a prompt for the LLM to answer the user query, wherein the prompt includes a listing of the subset of source databases.

13. The one or more hardware storage devices of claim 12, wherein the instructions are further executable to cause the one or more processors to:
cause the LLM to execute the prompt, resulting in the LLM generating an answer to the user query, wherein the LLM generates the answer to the user query by querying at least one source database included in the subset of source databases.

14. The one or more hardware storage devices of claim 11, wherein tagging the subset of source databases involves adding the subset of source databases to a prompt for the LLM.

15. The one or more hardware storage devices of claim 11, wherein a number of source databases included in the subset of source databases is less than 50% of a number of source databases included in the plurality of source databases.

16. The one or more hardware storage devices of claim 11, wherein a number of source databases included in the subset of source databases is less than 5.

17. The one or more hardware storage devices of claim 11, wherein, after the LLM provides an answer to the user query using one or more source databases included in the subset of source databases, user feedback is received, the user feedback indicating either success or failure on a part of the LLM in providing the answer, and wherein the PQ database is updated based on the user feedback.

18. The one or more hardware storage devices of claim 11, wherein, during an offline phase of the PQ database, the PQ database is seeded with initial embedding data.

19. The one or more hardware storage devices of claim 11, wherein some, but not all, of the source databases in the subset of source databases are used by the LLM in generating an answer to the user query.

20. A computer system comprising:
one or more processors; and
one or more hardware storage devices that store instructions that are executable by one or more processors to cause the computer system to:
access a retrieval augmented generation (RAG) system having access to a plurality of source databases, wherein the plurality of source databases are accessible by a large language model (LLM) that is tasked with answering user queries, the LLM relying on the plurality of source databases to answer the user queries;
access a user query submitted to the RAG system, wherein an embedding is generated for the user query;
access a past query (PQ) database that stores embeddings of previous user queries that have been categorized as having been successfully responded to by the LLM;
retrieve, from the PQ database, a select number of previous user queries that are determined to have a threshold level of similarity to said user query;
identify a set of source databases from among the plurality of source databases, the set of source databases being ones used by the LLM in successfully responding to the select number of previous user queries;
generate a weighted score for each source database included in the set of source databases;
rank the weighted scores for the source databases in the set of source databases;
generate a subset of source databases by filtering the set of source databases based on the ranked weighted scores; and
tag the subset of source databases as ones that the LLM is to potentially use when the LLM generates a response to said user query.
